(19) United States
(12) Patent Application Publication
(10) Pub. No.: US 2019/0387088 A1
(43) Pub. Date: Dec. 19, 2019

(54) SMART RINGTONE CONTROL

(71) Applicant: QUALCOMM Incorporated, San Diego, CA (US)

(72) Inventors: Vimal SINGH, Hyderabad (IN); Vaman Rajaram KALKUNDRIKAR, Hyderabad (IN)

(21) Appl. No.: 16/008,473

(22) Filed: Jun. 14, 2018

(51) Int. Cl. H04M 1/60; G06F 3/16; G06K 9/62; G06K 9/00

(52) U.S. Cl. CPC H04M 1/605; G06K 9/00362; G06K 9/6215; G06F 3/165

(57) ABSTRACT

Various additional and alternative aspects are described herein. In some aspects, the present disclosure provides a method of adjusting a ringtone volume of an electronic device. In certain aspects, the method includes determining whether a human body is within a proximity threshold of the electronic device using a proximity sensor, in response to a ringtone event. The method also includes using a first ringtone with a first volume to alert a user about the ringtone event upon determining that the human body is within the proximity threshold. The method also includes using a second ringtone with a second volume to alert the user about the ringtone event, upon determining that the human body is not within the proximity threshold wherein the first volume is lower than the second volume.

### FIELD

The present disclosure relates generally to wireless communication, and more particularly, to a smart ringtone control.

### BACKGROUND

Users of mobile devices generally tend to set the ringtone volume of their devices at maximum volume to ensure that an incoming call, text, or notification is not missed. Setting the ringtone volume at maximum volume may be beneficial when the user of a mobile device is away from the device. However, when the user is close to the mobile device, in some cases, it might not be beneficial or desirable for the user to hear the ringtone at maximum volume. In addition, playing a ringtone at a high volume consumes more power that playing the ringtone at a lower volume. It is, therefore, not resource efficient to alert a user by playing a ringtone with a high volume when the user is close to mobile device.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

Certain aspects of the present disclosure provide a method performed by an electronic device. The method includes determining whether a human body is within a proximity threshold of the electronic device using a proximity sensor, in response to a ringtone event. The method further includes, upon determining that the human body is within the proximity threshold, using a first ringtone with a first volume to alert a user about the ringtone event. The method further includes upon determining that the human body is not within the proximity threshold, using a second ringtone with a second volume to alert the user about the ringtone event, wherein the first volume is lower than the second volume.

Certain aspects of the present disclosure provide an electronic device comprising a proximity sensor, a non-transitory memory comprising instructions for adjusting a ringtone volume of the electronic device based on information provided by the proximity sensor, and a processor in data communication with the non-transitory memory and configured based on the instructions to determine whether a human body is within a proximity threshold of the electronic device using a proximity sensor, in response to a ringtone event. The processor is further configured to use a first ringtone with a first volume to alert a user about the ringtone event upon determining that the human body is within the proximity threshold. The processor is further configured to use a second ringtone with a second volume to alert the user about the ringtone event, wherein the first volume is lower than the second volume upon determining that the human body is not within the proximity threshold.

Certain aspects of the present disclosure provide an apparatus comprising means for determining whether a human body is within a proximity threshold of the electronic device using a proximity sensor, in response to a ringtone event. The apparatus further comprises, upon determining that the human body is within the proximity threshold, means for using a first ringtone with a first volume to alert a user about the ringtone event. The apparatus further comprises, upon determining that the human body is not within the proximity threshold, means for using a second ringtone with a second volume to alert the user about the ringtone event, wherein the first volume is lower than the second volume.

Aspects generally include methods, apparatus, systems, computer program products, computer-readable medium, and processing systems, as substantially described herein with reference to and as illustrated by the accompanying drawings. “LTE” refers generally to LTE, LTE-Advanced (LTE-A), LTE in an unlicensed spectrum (LTE-whitespace), etc.

### BRIEF DESCRIPTION OF THE DRAWINGS

FIG. 1 is a simplified block diagram of an example electronic device, in accordance with certain aspects of the present disclosure.

FIG. 2 illustrates examples positions of one or more proximity sensors within an electronic device, in accordance with certain aspects of the present disclosure.

FIG. 3 illustrates example operations performed by an electronic device, in accordance with certain aspects of the present disclosure.

FIG. 4 illustrates an example flowchart that includes a decision tree for an electronic device to determine a ringtone and/or a ringtone volume to use in response to the occurrence of a ringtone event, in accordance with certain aspects of the present disclosure.

FIG. 5 illustrates an example of an electronic device adjusting a ringtone volume of a playing ringtone and/or changing the playing ringtone based on the distance or proximity between a human body and the electronic device, in accordance with certain aspects of the present disclosure.

### DETAILED DESCRIPTION

Certain aspects herein relate to adjusting the ringtone volume and/or ringtone of an electronic device based on a user's proximity to the electronic device. In particular, certain aspects herein relate to the utilization of proximity sensors in an electronic device to determine the proximity (e.g., distance) of a human body to the device. In certain aspects, based on whether the electronic device is within a certain proximity (e.g., threshold distance) of a human body, the electronic device may be configured to adjust the device's ringtone volume and/or ringtone when playing a ringtone in response to a ringtone event. A ringtone event may include an incoming call, text, or notification or an alarm going off, etc.

In some embodiments, the electronic device may be any device configured to wirelessly communicate with other devices. The electronic device may support one or more of a variety of cellular technologies such as the long term evolution (LTE), MuLTEFire, 5G new radio (NR), etc. The electronic device, in some embodiments, may be a mobile device such as a laptop, a notepad, a cellular phone etc. In some embodiments, the electronic device may be a non-mobile device.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Certain apparatus and methods are described in the following detailed description and illustrated in the accompanying drawings by various blocks, modules, components, circuits, steps, processes, algorithms, etc. (collectively referred to as “elements”). These elements may be implemented using hardware, software, or combinations thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functions described throughout this disclosure. One or more processors in the processing system may execute software. Software shall be construed broadly to mean instructions, instruction sets, code, code segments, program code, programs, subprograms, software modules, applications, software applications, software packages, firmware, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, or combinations thereof If implemented in software, the functions may be stored on or encoded as one or more instructions or code on a non-transitory computer-readable medium. Computer-readable media includes computer storage media. Storage media may be any available media that can be accessed by a computer. By way of example, and not limitation, such computer-readable media can comprise RAM, ROM, EEPROM, PCM (phase change memory), flash memory, optical disk storage, magnetic disk storage or other magnetic storage devices, or any other medium that can be used to carry or store desired program code in the form of instructions or data structures and that can be accessed by a computer.

### Example Smart Ringtone Control

As discussed, certain aspects herein relate to adjusting an electronic device's ringtone volume and/or ringtone when playing a ringtone in response to a ringtone event, based on whether the electronic device is within a certain proximity of a human body.

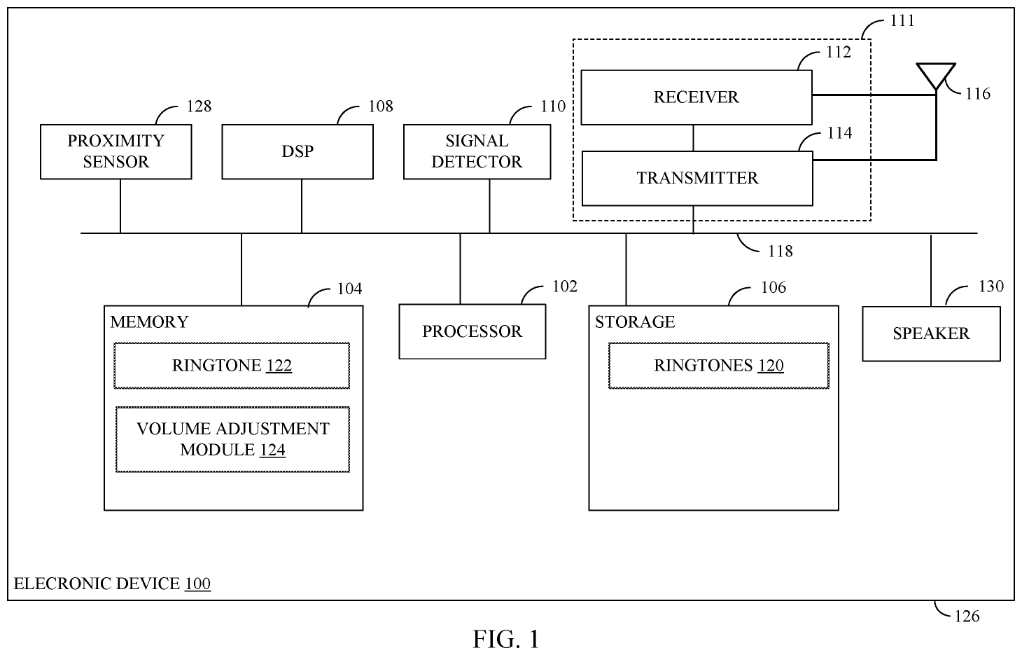

FIG. 1 is a simplified block diagram of an electronic device 100. Electronic device 100 is an example of a device that may be configured to implement the various methods described herein.

In certain aspects, electronic device 100 includes a processor 102 which controls the operations of electronic device 100. Processor 102 may also be referred to as a central processing unit (CPU). Memory 104, which may include both read-only memory (ROM) and random access memory (RAM), provides instructions and data to processor 104. Processor 102 typically performs logical and arithmetic operations based on program instructions stored within memory 104.

As shown, memory 104 includes a volume adjustment module 124 that comprises instructions for execution by processor 102 to implement one or more of the operations described herein. For example, when executed by processor 102, volume adjustment module 124 adjusts the volume of a ringtone based on input received from proximity sensor 128 that indicates whether electronic device 100 is in proximity to a human body. Volume adjustment module 124 may additionally or alternatively change the ringtone that is being played based on the input received from proximity sensor 128. Memory 104 also includes a ringtone 122 that may be selected, based on the configuration of electronic device 104, and retrieved from ringtones 120 stored in storage 106. Storage 106 is a non-volatile storage component, such as a flash memory, for storing information. Ringtones 120, stored in storage 106, may include a plurality of ringtones available for playback by speaker 130. In response to a ringtone event, one of ringtones 120 (e.g., ringtone 122) may be selected, based on the configuration of electronic device 100, and played back.

Electronic device 100 also has a housing 126 including a radio 111 (e.g., configured to act as a transceiver). Radio 111 includes a transmitter 114 and a receiver 112 to allow transmission and reception of radio signals between electronic device 100 and other communications devices. As an example, radio 111 enables electronic device 100 to send/receive calls, text messages, notifications, etc., from other devices. An antenna 116 may be electrically coupled to radio 111 for receiving and transmitting radio signals. In certain aspects, antenna 116 is included in housing 126 as shown. Alternatively, antenna 116 may be outside of housing 126 (e.g., attached to housing 126). Further, though only a single antenna 116 is shown as coupled to radio 111, radio 111 may be coupled to additional antennas. For example, each of transmitter 114 and receiver 112 may be coupled to separate antennas.

Electronic device 100 may also include a signal detector 110 that may be used in an effort to detect and quantify the level of signals received by receiver 112. Signal detector 110 may detect such signals as total energy, energy per subcarrier per symbol, power spectral density and other signals. Electronic device 100 may also include a digital signal processor (DSP) 108 for use in processing signals.

Electronic device 100 may further include a proximity sensor 128. Proximity sensor 128 is able to distinguish the human body from other material or objects (e.g., inert objects). In some embodiments, proximity sensor 128 may include a Specific Absorption Rate (SAR) proximity sensor. Accordingly, proximity sensor 128 is able to determine whether electronic device 100 is in proximity of a human body (“proximity determination”). In some embodiments, proximity sensor 128 is non-directional such that it is not necessary for proximity sensor 128 to be directly facing the human body in order to sense its proximity.

In some embodiments, proximity sensor 128 may be configured with a proximity threshold or range, such that when a human body is within such a proximity threshold, proximity sensor 128 indicates to processor 102 that electronic device 110 is within the proximity of a human body. However, if proximity sensor 128 does not sense a human body within the proximity threshold, it indicates that a human body is not within the proximity of electronic device 110. Based on whether a human body is or is not within the proximity threshold of electronic device 100, the ringtone volume or ringtone of electronic device 100 may be altered, as further described below.

In some embodiments, proximity sensor 128 may be configured to periodically make a proximity determination. Proximity sensor 128 may, in some embodiments, include a memory component to store a proximity determination. A proximity determination may then be read by, for example, processor 102 from the memory component of proximity sensor 102. In some embodiments, proximity sensor 102 may report a proximity determination (e.g., transmit it through bus system 118) to memory 104 or processor 102.

In some embodiments, if proximity sensor 128 senses that a human body is within the proximity threshold, proximity sensor 128 may also be configured to determine the distance between electronic device 100 and a human body. For example, proximity sensor 128's proximity threshold may be X (e.g., measured in inches, feet, meters, etc.). In such an example, if a human body is within the X threshold, proximity sensor 128 may be configured to determine the distance between electronic device 100 and the human body. For example, proximity sensor 128 may determine that the human body is within X/2 of electronic device 100.

Accordingly, in embodiments where proximity sensor 128 is configured to make periodic proximity determinations, proximity sensor 128 is able to determine a change in the distance between electronic device 100 and the human body. For example, at time t1, proximity sensor may make a proximity determination indicating that a human body is within X*3/4 distance of electronic device 100. At time t2, proximity sensor 128 may make another proximity determination indicating that the human body is now only within X/2 distance of electronic device 100 or that the human body is no longer within the X proximity threshold. Based on the change in the distance between electronic device 100 and the human body, electronic device 100 may adjust the ringtone volume or ringtone, as further described below. In some embodiments, the configuration of the proximity threshold of proximity sensor 128 may be changed or adjusted. For example, proximity sensor 128 may be configured to determine that a human body is within the proximity of electronic device 100 if the human body is within 2 inches of the device. However, the manufacturer of electronic device 100 or its user may change proximity threshold to 3 inches, or 3 feet.

Although a single proximity sensor 128 is shown in FIG. 1, electronic device 100 may include a plurality of proximity sensors 128. Proximity sensor 128 may be positioned in one of the described components of electronic device 100, on or attached to one of the described components, in another position in housing 208, or integrated into housing 208 in any position in housing 208. In embodiments where electronic device 100 includes a plurality of proximity sensors 128, each of the proximity sensors 128 may be positioned differently. For example, one proximity sensor 128 may be positioned on one side of electronic device 100 and another may be placed on the other side. In some other embodiments, a plurality of proximity sensors 128 may all be positioned together.

The various components of the electronic device 100 may be coupled and communicate together by a bus system 118, which may include a power bus, a control signal bus, and a status signal bus in addition to a data bus.

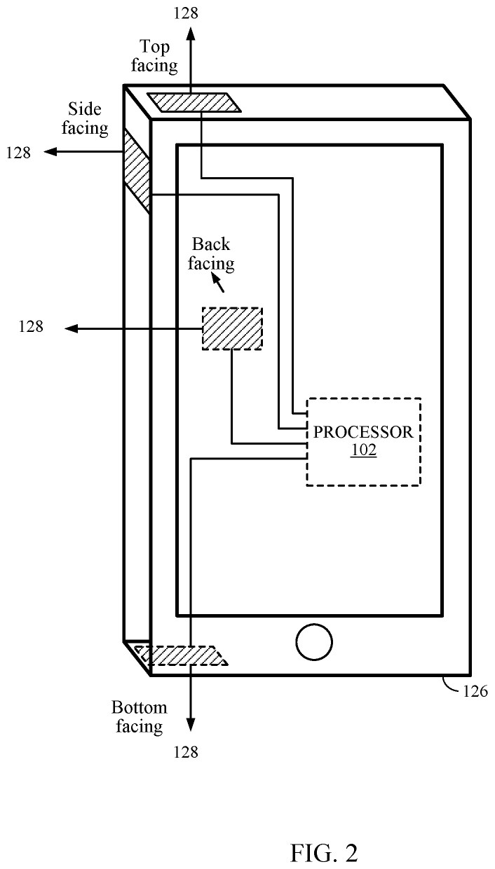

FIG. 2 illustrates example positions of one or more proximity sensors 128 within electronic device 100. As shown, proximity sensor 128 may be a top-facing sensor positioned on top of housing 126. In another example, proximity sensor 128 may be a bottom-facing sensor positioned on the bottom of housing 126. Proximity sensor 128 may also be positioned on either side of housing 126. In yet another example, proximity sensor 128 may be a back-facing sensor positioned on the back of housing 126. In embodiments where there is more than one proximity sensor 128, they may be placed together or separately in one or more of the positions shown in FIG. 2. The one or more proximity sensors 128 of electronic device 100 are all connected to processor 102 for providing input to processor 102.

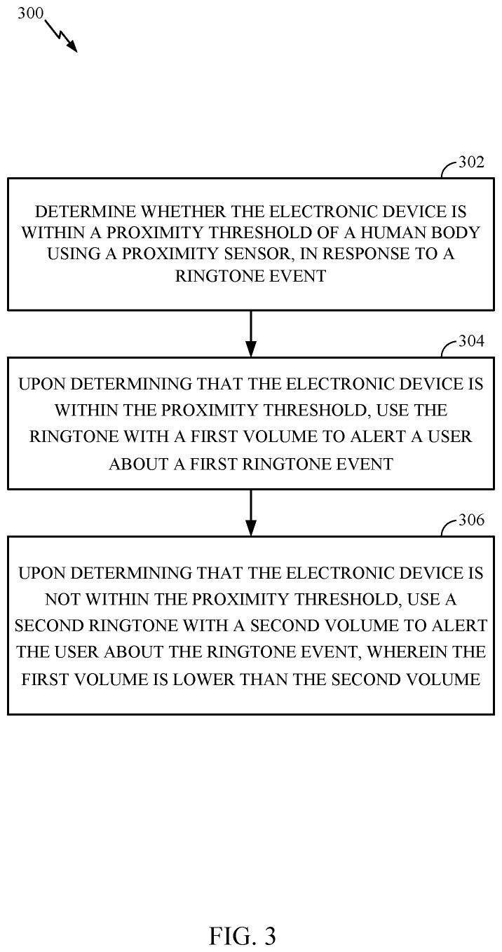

FIG. 3 is a flow diagram illustrating example operations 300 performed by an electronic device (e.g., electronic device 100) for adjusting a ringtone volume and/or ringtone of the device based on whether the electronic device is within a proximity threshold of a human body.

At step 302, the electronic device determines whether a human body is within a proximity threshold of the electronic device using a proximity sensor, in response to a ringtone event. A ringtone event is any functionality of the electronic device that may require the electronic device to play a ringtone. In some embodiments, the ringtone event may include an incoming call, text, or notification or an alarm going off, etc. The occurrence of a ringtone event indicates to the electronic device's processor (e.g., processor 102) to direct the device's speaker (e.g., speaker 130) to play a ringtone. A ringtone includes a sound (e.g., melody, music, alarm) that is played by the electronic device in response to a ringtone event.

In some embodiments, in response to the occurrence of the ringtone event, the processor executes certain instructions (e.g., volume adjustment module 124) to determine whether the electronic device is within a proximity threshold of a human body using a proximity sensor (e.g., proximity sensor 128). For example, in some embodiments, in response to the occurrence of the ringtone event, the processor may request the proximity sensor to provide input on whether the electronic device is within a proximity threshold of a human body. In response, the proximity sensor may make that determination and provide an input to the processor. In some other embodiments, the proximity sensor may be configured to periodically (e.g., every few milliseconds) make a determination about whether the electronic device is in a certain proximity threshold of a human body. In such embodiments, the proximity sensor may be configured to store the latest determination in a memory component of the proximity sensor or, alternatively, report the latest determination to the processor or a memory component (e.g., memory 104) of the electronic device. The processor then utilizes the latest determination in order to determine the volume for use in playing a ringtone.

At 304, upon determining that a human body is within the proximity threshold of the electronic device, the electronic device uses a first ringtone with a first volume to alert a user about the ringtone event. For example, based on an input from the proximity sensor indicating that a human body is within the proximity threshold, the electronic device's processor may direct the speaker (e.g., speaker 130) to play a ringtone at a volume that is lower than the maximum volume. This is because if the user of the electronic device is very close to the device, it is irritating and not resource efficient to play the ringtone at a high volume. The first volume may be configurable and adjustable by a user of the device. In some embodiments, the first volume may be zero decibels such that if the human body is within the proximity threshold, the electronic device may be silent. In other words, if the human body is within the proximity threshold, the electronic device may not play a ringtone. In such embodiments, the electronic device may alert the user by showing user interface elements, on the electronic device's user interface, that are indicative of an incoming call. In some embodiments, when the human body is within the proximity threshold, the first volume may be zero decibels but the electronic device may vibrate.

At 306, upon determining that a human body is not within the proximity threshold of the electronic device, the electronic device uses a second ringtone with a second volume to alert a user about the ringtone event. For example, based on an input from the proximity sensor indicating that a human body is not within the proximity threshold, the electronic device's processor may direct the speaker to play a second ringtone (e.g., the same ringtone as the first ringtone or a different ringtone) at a volume that is higher than the volume (e.g., first volume) used when the electronic device is within the proximity threshold. In one example, the second volume is the maximum volume allowed by the electronic device. Similar to the first volume, the second volume is also configurable and adjustable by a user of the device.

In some embodiments, the first ringtone and the second ringtone may be the same. In some other embodiments, the second ringtone may be more alarming than the first ringtone in an effort to ensure that the user of the device is alerted. For example, the second ringtone may be more pulsating and upbeat than the first ringtone. The first ringtone and the second ringtone are also configurable and adjustable by the user.

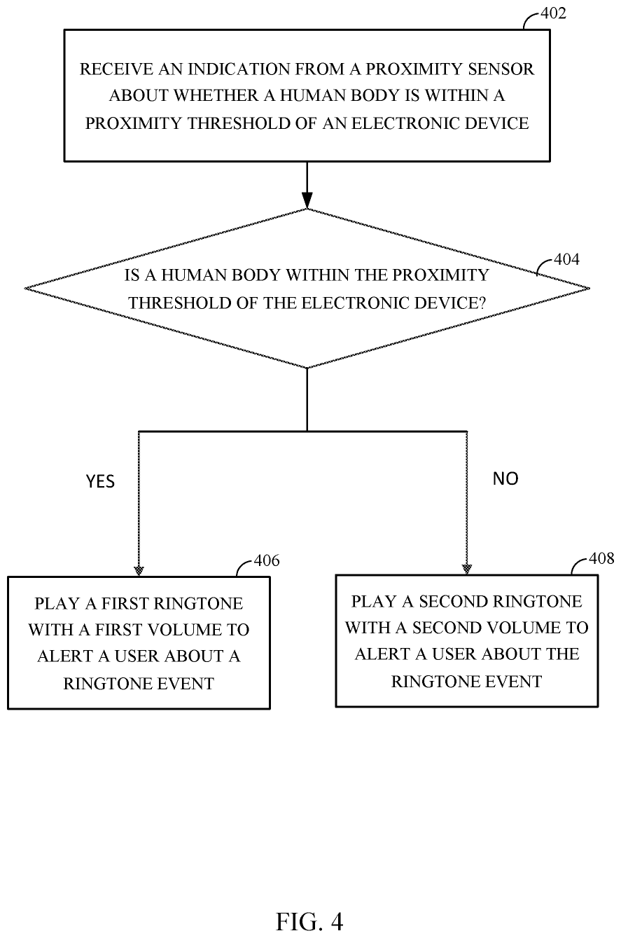

FIG. 4 illustrates an example flowchart that includes a decision tree for an electronic device to determine a ringtone and a ringtone volume to use in response to the occurrence of a ringtone event.

At 402, the electronic device's processor receives an indication about whether a human body is within a proximity threshold of an electronic device.

At 404, the electronic device's processor determines whether a human body is within the proximity threshold of the electronic device, based on the indication. If yes, the processor executes step 406 of the operation. If no, the processor executes step 408 of the operation.

At step 406, the electronic device's processor directs the device's speaker to play a first ringtone with a first volume to alert a user about a ringtone event. As discussed above, in some embodiments, if the human body is within the proximity threshold, the electronic device may be silent and alert the user by showing user interface elements, on the electronic device's user interface, that are indicative of an incoming call. In some embodiments, if the human body is within the proximity threshold, the electronic device may vibrate.

At step 408, the electronic device's processor directs the device's speaker to play a second ringtone with a second volume to alert a user about the ringtone event. As described in relation to FIG. 3, the first volume is lower than the second volume. Also, in some embodiments, the first ringtone and the second ringtone are the same, and in some embodiments, they are different.

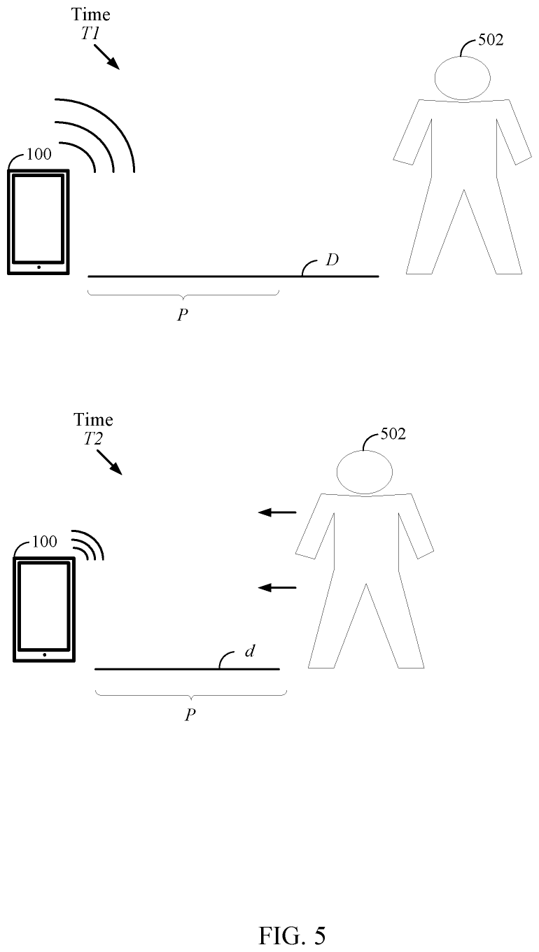

FIG. 5 illustrates an example of how an electronic device 100 may adjust a ringtone volume of a playing ringtone and/or change the playing ringtone based on the distance or proximity between a human body 502 and the electronic device. As described above, in some embodiments, the electronic device's proximity sensor (e.g., proximity sensor 128) may periodically make proximity determinations, based on which, the proximity sensor may determine a change in distance between the electronic device 100 and a human body. Based on the change in distance, the electronic device may accordingly change or adjust the ringtone volume of a ringtone that is already being played by the speaker. In some embodiments, the electronic device may also change the ringtone that is being played.

As an example, in response to an incoming voice call, at time Tl, the electronic device may determine that a maximum volume should be used to play a ringtone for alerting the user because the proximity sensor indicates (“first proximity determination”) that a human body is not within the proximity threshold (“P”). As shown, at T1, human body 502's distance with electronic device 100 is D, which is longer than P. The electronic device then plays the ringtone at maximum volume.

However, a subsequent proximity determination (“second proximity determination”) made, at T2, by the proximity sensor during the time period when the ringtone is played may indicate that a human body is within the proximity threshold. As shown, at T2, human body 502 is at a distance of d with electronic device 100 and, therefore, within proximity threshold P. In such an example, the electronic device may be configured to adjust the ringtone volume by lowering it and/or change the ringtone that is being played to a less alarming or pulsating ringtone. If, however, the first proximity determination indicates that the human body is within the proximity threshold and the second proximity threshold indicates otherwise (not shown), then the electronic device may be configured to adjust the ringtone volume by increasing it and/or changing the ringtone to a more alarming or pulsating ringtone.

In another example (not shown), both the first proximity determination and the second proximity determination may indicate that human body 502 is within the proximity threshold. However the location of human body 502 within the proximity threshold may change during the time period between the first proximity determination and the second proximity determination. In such an example, the electronic device may similarly change the ringtone volume of the ringtone being played and/or the ringtone itself based on a change in the location of human body 502. For example, the first proximity determination may indicate that that electronic device 100 and human body 502 have a D1 distance from each other. Based on the first proximity determination, electronic device 100 may begin using a first ringtone with a first volume to alert the user. If, during the time period when the first ringtone is being played, the second proximity determination indicates a D2 distance that is larger than the D1 distance, then electronic device may increase the first volume and/or change first ringtone to a second ringtone (e.g., a more alarming ringtone). However, if during the time period when the first ringtone is being played, the second proximity determination indicates a D2 distance that is smaller than the D1 distance, then electronic device may lower the first volume and/or change first ringtone to another ringtone (e.g., a less alarming ringtone).

Accordingly, the smart ringtone control described herein results in resource efficiency by ensuring that an electrical device is not wasting power to play a ringtone at a very high volume when a user is within a certain distance from the device. In addition, the smart ringtone control described herein improves user experience by using a ringtone and/or ringtone volume to increase the likelihood that the user is alerted about a certain ringtone event while not irritating the user with an excessively loud and/or alarming ringtone.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

Moreover, the term “or” is intended to mean an inclusive “or” rather than an exclusive “or.” That is, unless specified otherwise, or clear from the context, the phrase, for example, “X employs A or B” is intended to mean any of the natural inclusive permutations. That is, for example the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. A phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. A method of adjusting a ringtone volume of an electronic device, comprising:
determining whether a human body is within a proximity threshold of the electronic device using a proximity sensor, in response to a ringtone event; and
upon determining that the human body is within the proximity threshold:
using a first ringtone with a first volume to alert a user about the ringtone event;
upon determining that the human body is not within the proximity threshold:
using a second ringtone with a second volume to alert the user about the ringtone event, wherein the first volume is lower than the second volume.

2. The method of claim 1, wherein the proximity sensor distinguishes the human body from other objects.

3. The method of claim 1, wherein the proximity sensor is a Specific Absorption Rate (SAR) proximity sensor.

4. The method of claim 1, wherein during a time period when the first ringtone with the first volume is used:
determining whether the human body is within the proximity threshold of the electronic device using the proximity sensor; and
upon determining that the human body is within the proximity threshold:
continuing to use the first ringtone with the first volume to alert the user about the ringtone event;
upon determining that the human body is no longer within the proximity threshold:
using the second ringtone with the second volume to alert the user about the ringtone event.

5. The method of claim 1, wherein during a time period when the second ringtone with the second volume is used:
determining whether the human body is within the proximity threshold of the electronic device using the proximity sensor; and
upon determining that the human body is within the proximity threshold:
using the first ringtone with the first volume to alert the user about the ringtone event;
upon determining that the human body is still not within the proximity threshold:
continuing to use the second ringtone with the second volume to alert the user about the ringtone event.

6. The method of claim 1, wherein determining that the human body is within the proximity threshold further comprises determining a first distance between the electronic device and the human body.

7. The method of claim 6, wherein during a time period when the first ringtone with the first volume is used:
determining a second distance between the electronic device and the human body; and
upon determining that the first distance is larger than the second distance:
continuing to use the first ringtone and lowering the first volume;
upon determining that the first distance is smaller than the second distance:
using a second ringtone with and increasing the first volume.

8. The method of claim 1, wherein the first ringtone is a same ringtone as the second ringtone.

9. The method of claim 1, wherein the first ringtone is different from the second ringtone.

10. A electronic device comprising:
a proximity sensor;
a non-transitory memory comprising instructions for adjusting a ringtone volume of the electronic device based on information provided by the proximity sensor;
a processor in data communication with the non-transitory memory and configured based on the instructions to:
determine whether a human body is within a proximity threshold of the electronic device using a proximity sensor, in response to a ringtone event; and
upon determining that the human body is within the proximity threshold:
use a first ringtone with a first volume to alert a user about the ringtone event;
upon determining that the human body is not within the proximity threshold:
use a second ringtone with a second volume to alert the user about the ringtone event, wherein the first volume is lower than the second volume.

11. The electronic device of claim 10, wherein the proximity sensor distinguishes the human body from other objects.

12. The electronic device of claim 10, wherein the proximity sensor is a Specific Absorption Rate (SAR) proximity sensor.

13. The electronic device of claim 10, wherein during a time period when the first ringtone with the first volume is used, the processor is further configured to:
determine whether the human body is within the proximity threshold of the electronic device using the proximity sensor; and
upon determining that the human body is within the proximity threshold:
continue to use the first ringtone with the first volume to alert the user about the ringtone event;
upon determining that the human body is no longer within the proximity threshold:
use the second ringtone with the second volume to alert the user about the ringtone event.

14. The electronic device of claim 10, wherein during a time period when the second ringtone with the second volume is used, the processor is further configured to:
determine whether the human body is within the proximity threshold of the electronic device using the proximity sensor; and
upon determining that the human body is within the proximity threshold:
use the first ringtone with the first volume to alert the user about the ringtone event;
upon determining that the human body is still not within the proximity threshold:
continue to use the second ringtone with the second volume to alert the user about the ringtone event.

15. The electronic device of claim 10, wherein determining that the human body is within the proximity threshold further comprises determining a first distance between the electronic device and the human body.

16. The electronic device of claim 15, wherein during a time period when the first ringtone with the first volume is used, the processor is further configured to:
determine a second distance between the electronic device and the human body; and
upon determining that the first distance is larger than the second distance:
continue to use the first ringtone and lower the first volume;
upon determining that the first distance is smaller than the second distance:
use a second ringtone and increase the first volume.

17. The electronic device of claim 10, wherein the first ringtone is a same ringtone as the second ringtone.

18. The electronic device of claim 10, wherein the first ringtone is different from the second ringtone.

19. An apparatus, comprising:
means for determining whether a human body is within a proximity threshold of the apparatus using a proximity sensor, in response to a ringtone event; and
upon determining that the human body is within the proximity threshold:
means for using a first ringtone with a first volume to alert a user about the ringtone event;
upon determining that the human body is not within the proximity threshold:
means for using a second ringtone with a second volume to alert the user about the ringtone event, wherein the first volume is lower than the second volume.

20. The apparatus of claim 19, wherein the proximity sensor distinguishes the human body from other objects.
